(19) United States
(12) Patent Application Publication
(10) Pub. No.: US 2020/0247700 A1
(43) Pub. Date: Aug. 6, 2020

(54) Multistage shower water filter and water filtering method

(71) Applicants: Andrey Genin, Hawthorne, CA (US); Siarhei Ulasevich, Hawthorne, CA (US)

(72) Inventors: Andrey Genin, Hawthorne, CA (US); Siarhei Ulasevich, Hawthorne, CA (US)

(21) Appl. No.: 16/265,059

(22) Filed: Feb. 1, 2019

(51) Int. Cl. C02F 9/00; B01D 35/04; B01D 39/04; B01D 39/06; B01D 27/08; B01D 27/10

(52) U.S. Cl. CPC C02F 9/005; B01D 35/043; B01D 39/04; B01D 39/06; B01D 27/08; B01D 2201/08; C02F 2307/06; C02F 2201/004; C02F 2201/006; B01D 2201/301; B01D 2101/02; B01D 27/105

(57) ABSTRACT

A multistage shower filter assembly for water filtering having an in-line reversible filter, changeable by unscrewing two portions of the housing. The housing exterior includes a plurality of gripping means to allow easy opening and closing of the housing and to prevent slippage of the hands of a user gripping the two portions, even when wet. The multistage shower filter assembly includes a separate internal multistage filter element that may be easily inserted into or removed from the multistage shower filter assembly to allow the internal filter element to be easily reversed for longer use.

### BACKGROUND OF THE INVENTION

### 1. Field of the Invention

This invention relates generally to shower water filters and more particularly to an improved, shower water filter assembly which is easily disassembled and reassembled for reversing the water filter element carried therein.

### BACKGROUND TECHNIQUE

The shower water filter with many stages is our original water cleaning system design. The utility patent is a process for water softening and removing of contaminants, irritants, bacteria, heavy metals, unpleasant odors.

The utility patent is a process to achieve water quality and stability, it relates to the inventory process to maintain water quality, and in particular provides for a stronger filtration, water softening and removing of contaminants, irritants, bacteria, heavy metals, unpleasant odors, disinfection, and stimulation of immunity.

The shower water filter with many stages promotes healthy skin, hair, and nails, with stronger filtration, disinfection, and stimulation of immunity. The additional filtration reduces the risk of developing skin or respiratory diseases such as eczema, dermatitis, bronchitis, or asthma, by removing chlorine and other chemicals. It also purifies the water from such bacteria as staphylococcus and E. coli, softens and removes contaminants, irritants, bacteria, heavy metals, unpleasant odors, toxic substances and harmful water bacteria.

Water is a basic way of civil defense, engineering solutions and other underground water supply reliability.

The current inventory of fresh water problem is poor water quality, mainly due to microbial growth. Long-term water microbial origin has two main aspects: (1) water in case of free water surface, airborne microorganisms floating into the water to form a suspension of growth; (2) the concentration gradient of nutrients can make the Brownian motion of bacteria from the water to move the wall surface bacteria by bridging the polymer as the main mechanism for reversible adhesion process and firmly adhered to the wall surface, a variety of microorganisms, secretions and broken shoulder in the wall surface deposition, attachment and growth. Many fungal metabolites can seriously affect human health, nutrient substances, microbial growth, that is to rely on assimilable organic carbon for the organic representatives.

For a long time, in order to control inventory freshwater microbial growth, are primarily repeatedly added chlorine preparations for disinfection measures, excessive use of disinfectants to stock water quality brought many uncertainties; security risks.

Utility Patent Content

The utility patent, intended to provide a process for removing impurities and achieve water quality and stability, belongs to the inventory process to maintain water quality, and more particularly provides for a stronger filtration, water softening and removing of contaminants, irritants, bacteria, heavy metals, unpleasant odors, disinfection and stimulation of immunity.

A method for removing microorganisms from water is provided by the invention.

The utility patent equipment is used to remove impurities, to achieve the quality and stability of the basic principles of the method on the basis of water filtration by the filtration stages with: granulated activated coconut carbon which is removing radioactive iodine-131, chlorine, chloramine, trihalomethanes, chemicals, impurities, and volatile organic chemicals (VOCs), it's a unique structure of polypropylene cotton with a surface area 3-8 times bigger than ordinary filters and is much more effective at removing turbidities, sediments, rust, and bacteria; kinetic degradation fluxion (KDF-55) process media which are high-purity copper-zinc granules that reduce heavy metals, chlorine and hydrogen sulfide contamination in water using an oxidation/reduction (redox) reaction; calcium sulfite which is 100 times more efficient than activated carbon in removing chlorine and heavy metals such as lead, iron, mercury, cadmium, and aluminum; alkaline ceramic balls, which are made of all natural minerals to enhance and revitalize water by antioxidant power, will boost your immune system and keep up the optimal health of your body; magnetic energy ceramic balls which are a set of natural tourmaline, germanium natural stones; nano silver antibacterial ceramic balls which are rich in silver ions that kill bacteria and deter bacterial growth by breaking down organic compounds that comprise bacteria, thus resisting to and killing golden staphylococcus and colibacillus; Kangen water ceramic filter discs, Kangen water plus ceramic balls, hydrogen water ceramic balls, oxidation/reduction water potential magnesium granules which make antioxidants bio ceramic balls, restore pH balance in your body, the anti-oxidant power strengthen body's immune system, micro-clustered water hydrate cells more effectively, essential minerals maintain optimal health, remove pesticide residues from fruits and vegetables, inhibit microbe breeding; alkaline water calcium ceramic balls, alkaline water plus antioxidant ceramic balls, oxidation/reduction potential water negative potential ceramic balls which increase pH about 7.0-11.0 as a requirement to make alkaline water, the anti-oxidant power strengthen body's immune system, micro-clustered water hydrate cells more effectively, essential minerals maintain optimal health, remove pesticide residues from fruits and vegetables, inhibit microbe breeding; tourmaline ceramic balls, maifan stone, potassium metasilicate ceramic balls, vitamin C ceramic balls which mineralize water, natural nonmetal mineral materials, eliminate the peculiar smell of the water, are rich in calcium, magnesium, sodium, potassium and other essential elements from natural pure minerals, improve biological activity of the water with dissolved oxygen concentration, strengthen and activate the physiological activities of the human body; microporous antibacterial ceramic balls, nano silver antibacterial ceramic balls which resist to and kill golden staphylococcus, resist to and kill colibacillus, absorb heavy metal ions, absorb organisms, remove pesticide residues from fruits and vegetables, micro-clustered water hydrate cells more effectively; negative ion ceramic balls which increase the emission rate of far-infrared ceramic balls into the water, increase air negative ion concentration, increase dissolved oxygen and activate water, micro-clustered water hydrate cells more effectively, essential minerals maintain optimal health, improve the taste of water, inhibit microbe breeding; zeolite bioceramic balls, activated alumina balls which are making water adsorption and purification better, have ion exchange properties: water softening, fluorine, heavy metal removal, desalination, have adsorption properties: drying agent, adsorption separation agent, molecular sieve (purification of gas and liquid), deodorant; laundry ceramic granules, laundry balls which are making natural cleaning better, are free from chemical and odor, no residue, keep colors of fabric, save water and power, replace the general washing detergent, remove various kinds of bacteria effectively; dechlorination balls, germanium balls, magnetic energy ceramic balls which all have better bath and cosmetic ceramic balls, strong capability of chlorine removal, far-infrared therapeutic function, excrete the toxins out of human bodies, increase blood oxygen content, keep skin and hair healthy and beautiful; aquarium ceramic granules, aquarium ceramic filled balls which all have higher surface area, increase biological activity, provide increased aeration, create better water quality, can be used individually or mixed in filter chamber for aquarium and pond ceramics filled balls; shungite, quartz, silicon pulp which all are making water quality better.

The layers are placed between mesh on both sides of the filter which act not just as a protection but as a final filter to remove dust and other bigger particles from water flow.

The Utility Patent has Significant Advantages

Body care: less risk of developing eczema asthma bronchitis, reduces dry itchy skin, dandruff cares about the health of the skin, hair, nails, helps to stimulate the immune system, removes toxins from the body, disinfects and kills Staphylococcus aureus and Escherichia coli, it is ideal for bathing children and your pets.

Purifies water: helps to faster remove chlorine, heavy metals, bacteria, pesticides, chloramine, smell ammonia, sulfur and other sediment and inhibits the growth of scale, algae, and mold in the bath tub.

Complete compatibility: can be placed overhead, handheld, rainfall, and combo shower heads for versatile home use. Protects filtered the whole shower in the house from dirty water. Consistent water pressure: our high-performance inline water filter won't reduce existing water pressure for an improved rinse. Acts as a moisturizer, purifier, and softener and gives the best feeling for sensitive skin body wash. This will help with rust, iron.

Softens water: is great for well water, as well as hard alkaline water.

Filters your water: The water shower head has a dechlorinating multistage shower filter that will also reduce dissolved solids. You won't have to sacrifice water pressure due to our micro-hole technology. The multistage shower filter is composed of a filter sponge and a cartridge of calcium sulfite stones. Its premium metal frame and over-sized 4.5″ face will enhance your shower by giving you full body coverage. The metal balls joint allows you to swivel the shower head so as you may adjust the direction of water flow.

Removes chlorine from your shower water: The water shower head will reduce 80-90% of the chlorine from your water along with dissolved solids; the inexpensive multistage shower filter will last for 6-8 months depending on your water use and amounts of dissolved solids in your water.

All metal: water shower heads on the market are plastic painted to look like metal; ours is composed entirely of metal excluding the internal filtration cartridge; it's a stationary wall-mounted shower head; the installation is a breeze with no tools required and connects to any standard overhead shower arm.

We live with too many chemicals: chlorine results in itchy skin and dry hair, thus chlorine removal from your shower water and reduction of dissolved solids is something you can do right now to combat this.

### 2. Description of Related Art

Water filtering means for attachment to or for use in conjunction with shower heads are known. These known filtering means may be inserted into a waterline, or replace an existing shower head, to filter water passing there through. However, after many attempts to solve the problems of clogging, ease in installation, back flushing and/or replacing the shower filter medium, as well as the high cost of manufacture, there still exists the need for a less cumbersome, easy to install and remove, low-cost shower filter assembly, that is also easily taken apart, to enable the filter element therein to be reversed for back flushing, thereby providing better water filtering capabilities, longer life of the filter element, and less waste.

One known prior art device is shown in U.S. Pat. No. 2,582,388 to Mansfield, which discloses a water filter for attachment to a water faucet having screwed together housings to enable the filter assembly to be opened for recharging the filter material therein. This patent also discusses the ability of the filter to be self-cleaning by reversing the filter on the faucet to reverse the flow of fluid through the same to flush out any impurities contained therein. This filter, however, is not readily adapted for use in a shower head for filtering out the impurities in hot water passing there through, and does not present or contemplate the reversing of a separate filter element contained within a shower filter, after unscrewing two portions of a housing.

In U.S. Pat. No. 4,993,080 to Rundzaitis et al., there is disclosed a shower filter having a replaceable filter cartridge. However, the replaceable filter cartridge is supported in a housing which is offset from the water flow, i.e., which is not in-line, thereby requiring direction control and valving means to direct the water from the entering water line into the offset filter cartridge.

U.S. Pat. No. 5,213,688 to Robinson, discloses a shower water filter, for insertion into a waterline, having a laterally displaced, or offset, cavity or compartment for holding a filter element. The filter element may be replaced by unscrewing a canister portion from a base portion, but no mention is made of reversing the filter element.

U.S. Pat. No. 5,300,224 to Farley, discloses a one piece shower water filter/dechlorinator assembly having a removable diverter/screen element at the inlet end to enable filter material to be initially inserted and held in the housing, as well as for recharging the filter, for dechlorinating water passing there through.

While the foregoing prior art patents solve some of the problems with the filtration and/or dechlorination of water in showers, they do not overcome all of the known difficulties, such as, but not limited to, problems with taking apart existing shower filters, back flushing of cartridges or filters to clean the same in an attempt to improve their efficiency and to avoid having to replace them as often, ease in manufacture and installation, and the provision of a continued, desired degree of filtration of water passing directly through an in-line device, providing extended filtering capabilities. Furthermore, while the above-mentioned prior art provide some limited improvements in the filtering art, there remains the need in the art for a shower filter assembly that provides a maximum of filtering and other capabilities in an easily opened design, allowing reversal or rotation of an internal filtering element, at a reasonable price.

### SUMMARY OF THE INVENTION

Accordingly, it is a general object of the present invention to provide an improved multistage shower filter assembly. It is a particular object of the present invention to provide an easily opened multistage shower filter assembly. It is a still more particular object of the present invention to prove a shower water filter assembly in which an internal filter element to be easily reversed. It is a further object of the present invention to provide a shower water filter that unscrews to allow an internal filter element to be reversed and reinserted for back flushing, as required.

In accordance with one aspect of the invention, there is provided a multistage shower filter assembly having two separate housing members which are easily taken apart to allow an internal filter element to be reversed and reinserted for further use, so as to prevent the multistage shower filter from clogging and limiting the flow of water there through. The two separate housing members of the multistage shower filter assembly are provided with easily gripped external surfaces to make it as easy as possible to separate and reattach the housing members.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a side elevational view of the preferred embodiment of the multistage shower water filter assembly of the present invention;

FIG. 2 is a sectional view taken along line 2-2 of FIG. 1, looking in the direction of the arrows; and

FIG. 3 is an exploded view of the multistage shower water filter of the present invention, showing the separate housing portions and an internal filter housing containing a filter medium therein which may be removed and/or rotated upon opening thereof.

FIG. 4 is a side elevational view and partly sectional view of the preferred embodiment of the multistage shower water filter and shower head assembly of the present invention, also showing an adapter between the shower water filer and shower head assembly;

### DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide an improved shower water filter assembly.

It has been found by long use and experiment that there is so much water flowing through the filter material in a shower water filter that the multistage shower filter must be cleaned, i.e., backflushed, and/or the filter material or multistage shower filter actually replaced much more frequently than previously thought. In fact it is now recommended by some multistage shower filter manufacturers that the shower filter be backflushed at least every thirty (30) days. In addition, depending on the quality of the water in a given area, and the temperature of the water flowing through the shower filter, the length of time between backflushing and/or changing may be shortened even further. However, with known shower water filters it is not convenient to backwash the filter and/or change the filter medium.

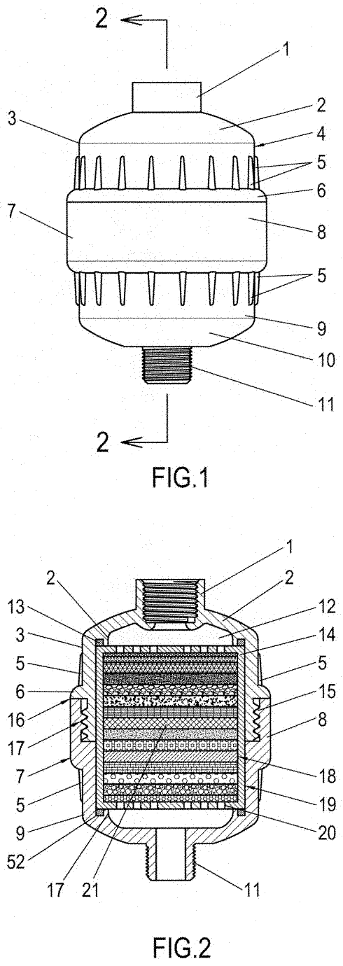

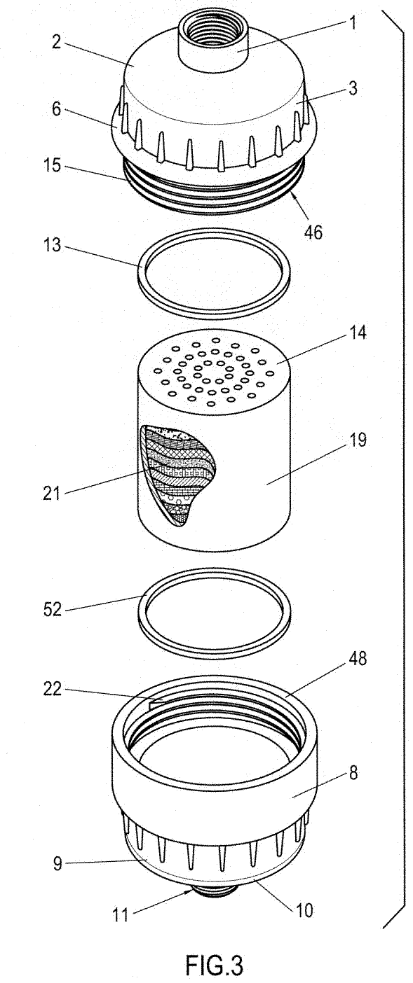

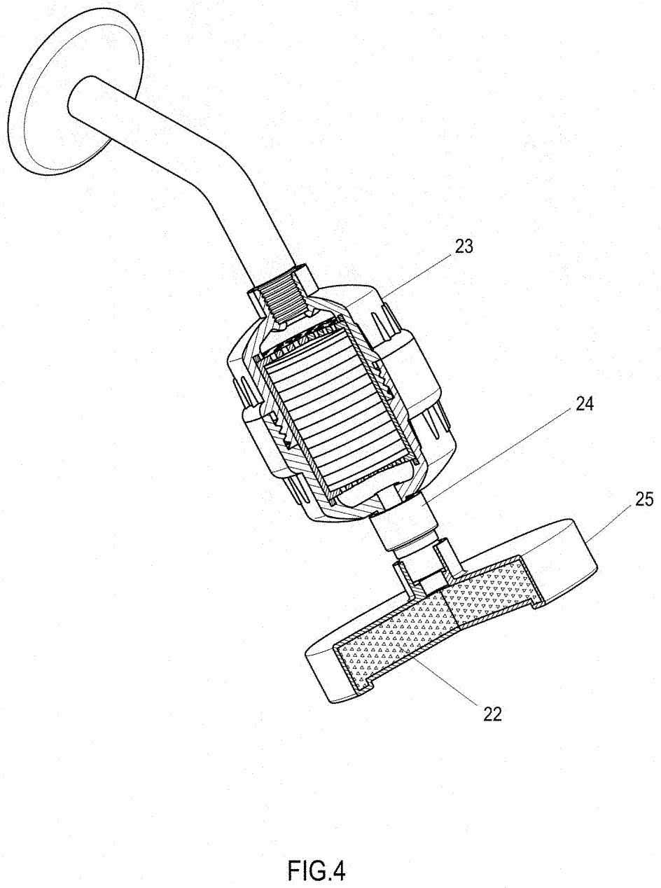

The device of the present invention provides for an easily opened device in which a shower water filter may have its internal filter, containing the filter media backflushed at regular intervals. Turning now to the drawings, FIGS. 1-3 show a shower water filter assembly 4 of the present invention, adapted to be secured between the outlet end of a shower arm or waterpipe and a shower head (shown in FIG. 4), in a known manner. It will be readily apparent to those skilled in the art that the internally threaded inlet 1 may be secured to the end of a shower arm, or the like, while the exteriorly threaded outlet end 11 may be secured to the inlet of a shower head. The inlet 1 is secured to, or preferably formed integrally with, a first half of a body of a multistage shower filter, comprising a top or male portion 16. The top portion 2 is capable of being inserted and held in a second half of a body of a multistage shower filter, comprising a bottom or female portion 10, having the outlet 11 secured to, or preferably formed integrally therewith.

FIG. 4 shows an adapter 24 below the shower water filter assembly 23, and above a shower head 25, with medium 22 inside the shower head 25 also shown by way of a cut out view in FIG. 4.

The top portion 2 includes a securing means, such as an annular threaded lower portion 20, which cooperates with and is securely held in a further securing means, such as an internally threaded annular upper portion 17 of bottom portion 10. The annular internal threads of bottom portion 17 are secured to the annular threaded lower portion 15, in any desired manner, such as by a user holding onto a gripping area 3, 9 formed on the external surfaces of both the top portion 2 and bottom portion 10 and screwing the portions into each other. To allow the top and bottom portions to be more easily gripped and turned, gripping or non-slip means, such as a plurality of ribs 5 are formed integrally with the top and bottom portions 16, 10, in reduced diameter gripping areas 3, 9.

As shown, the assembly 4 is preferably substantially cylindrical in shape with substantially domed ends. The top portion 2 includes a raised lip 6 below gripping area 3, while bottom portion 10 includes a raised skirt, or the like 8, formed above the gripping area 9. Therefore, when the top and bottom portions 16 and 10 are screwed together, raised lip 6 and raised skirt 8 cooperate to form a raised central area 7 on the assembly 4, as shown in FIGS. 1 and 2. In use, the raised lip 6 will prevent water from entering between the assembled top and bottom portions.

When the top and bottom portions 16, 10 are assembled, an internal, hollow filter chamber 12 is contained within the assembly 4 and is bounded by the top and bottom portions. A filter element 19 is captured within the internal chamber 12, and includes a substantially flat, circular top wall 14, having a screen or the like therein to allow water from the inlet 1, to flow in the direction of the arrows, through the same, into an inner chamber 16 formed by an annular side wall 18. A substantially flat, circular bottom wall 20 having a further screen therein is secured to the other end of annular wall 18 to allow water to flow out the outlet 11 after having passed through filter media in the filter element 19. The walls 14, 18 and 20 of the filter element 19 are secured together in any desired manner, such as by being permanently bonded together with any desired filter media 21 filling inner chamber 16.

The upper and lower portions 16 and 10 of assembly 4 may be fabricated in any desired manner, using any acceptable material, such as by molding a plastic material to form the two portions in such a manner that they are sized and dimensioned so as to be capable of being easily sealingly screwed together and apart.

In use, the filter element 19 is first assembled with filter media 21 therein, and inserted into one of the upper and lower portions 16 and 10. These portions are then screwed together until the filter element 19 is securely held in chamber 12, between internal wall means 46, 48. To prevent water from bypassing the filter element 19 in the internal chamber 12, sealing means, such as O-ring seals 13, 52, are inserted and held in annular openings formed in each of the internal wall means 46, 48.

After having been used for a predetermined period of time in a shower, depending on the water being used, the filter media 21 in the filter element 19 will become partially blocked or clogged, thereby loosing its effectiveness and slowing down the flow of water through the multistage shower filter assembly 4. However, the upper and lower portions 16 and 10 may then be easily screwed apart, with the upper portion still attached to the shower arm, by gripping the gripping areas 3 and 9 and turning the same so as to separate the top and bottom portions and open the internal chamber 12. The filter element 19 may then be easily removed and reversed, i.e., turned 180 degrees, and the portions 16 and 10 screwed back together with the filter element 19 in this reversed position. Further flow of water through the reassembled filter, with the filter element 19 in the reversed position, will backflush the filter media 21 in the filter element to provide continued efficient use of the filter media in the filter element, and thereby provide for a longer useful life thereof, as well as the elimination of waste, some of it toxic, as occurs with current filters, which require the filter element and/or filter media to be discarded once blocked or clogged.

Accordingly, as will be apparent to those skilled in the art, the assembly of the present invention provides considerable advantages in ease and flexibility of manufacture, as well as the separating of the separate portions of the assembly, and the installation and removal of the filter element contained therein.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What I claim is:

1. An in-line multistage shower water filter assembly comprising, in combination:
a substantially cylindrical hollow body comprised of substantially cylindrical separable top and bottom housing portions having an internal hollow chamber formed there between;
the substantially cylindrical separable top housing portion including a first domed end, and a second open end, with a raised lip and an exteriorly threaded male portion adjacent said raised lip at said second open end, and the bottom housing portion including a first domed end, and a second open end, with a raised skirt and an interiorly threaded female portion adjacent said raised skirt, so that when said separable top and bottom housing portions are screwed together they will form a substantially cylindrical in-line shower water filter having a raised central strengthened area, formed by said raised lip and said raised skirt;
an inlet and an outlet connected to the respective first domed ends of said separable top and bottom housing portions to allow the flow of water into and out of said internal hollow chamber;
a separate multistage filter element mounted within said internal hollow chamber;
said separate filter element being held in said internal hollow chamber and clamped between said separable top and bottom housing portions by internal wall means, and having a top wall, a bottom wall and an annular side wall forming an inner hollow chamber;
a filter media substantially filling said inner hollow chamber of said separate multistage filter element, inside the body being incorporated the next filtration stages with: granulated activated coconut carbon filter, a unique structure of polypropylene cotton, kinetic degradation fluxion 55, calcium sulfite, alkaline ceramic balls, magnetic energy ceramic balls, nano silver antibacterial ceramic balls, Kangen water ceramic filter discs, Kangen water plus ceramic balls, hydrogen water ceramic balls, oxidation/reduction potential water magnesium granules, alkaline water calcium ceramic balls, alkaline water plus antioxidant ceramic balls, oxidation/reduction potential water negative potential ceramic balls, tourmaline ceramic balls, maifan stone, potassium metasilicate ceramic balls, vitamin C ceramic balls, microporous antibacterial ceramic balls, negative ion ceramic balls, far-infrared ceramic balls, zeolite bioceramic balls, activated alumina balls, laundry ceramic granules, laundry balls, dechlorination balls, germanium balls, magnetic energy ceramic balls, aquarium ceramic granules, aquarium ceramic-filled balls, shungite, quartz, silicon pulp; and
said separable top and bottom housing portions having interior and exterior surfaces and including gripping portions formed on the exterior surfaces thereof adjacent said raised lip and said raised skirt, said gripping portions being comprised of a plurality of strengthening ribs which allow said separable top and bottom housing portions to be more easily gripped when screwing them together or taking them apart.

2. A method for removing impurities from water of an in-line multistage shower water filter assembly comprising, in combination:
a substantially cylindrical hollow body comprised of separable substantially cylindrical top and bottom housing portions having an internal hollow chamber formed there between;
an inlet and an outlet connected to respective domed ends of said separable top and bottom housing portions to allow the flow of water into and out of said internal hollow chamber;
a separate multistage filter element mounted within said internal hollow chamber;
a separate multistage filter element mounted within shower head internal hollow chamber;
said separate filter element being held in said internal hollow chamber clamped between internal wall means formed on said separable top and bottom housing portions, and having a top wall, a bottom wall and an annular side wall forming an inner hollow chamber;
a filter media substantially filling said inner hollow chamber of said separate multistage filter element, inside the body being incorporated the next filtration stages with: granulated activated coconut carbon, unique structure of polypropylene cotton, kinetic degradation fluxion 55, calcium sulfite, alkaline ceramic balls, magnetic energy ceramic balls, nano silver antibacterial ceramic balls, Kangen water ceramic filter discs, Kangen water plus ceramic balls, hydrogen water ceramic balls, oxidation/reduction potential water magnesium granules, alkaline water calcium ceramic balls, alkaline water plus antioxidant ceramic balls, oxidation/reduction potential water negative potential ceramic balls, tourmaline ceramic balls, maifan stone, potassium metasilicate ceramic balls, vitamin C ceramic balls, microporous antibacterial ceramic balls, negative ion ceramic balls, far-infrared ceramic balls, zeolite bioceramic balls, activated alumina balls, laundry ceramic granules, laundry balls, dechlorination balls, germanium balls, magnetic energy ceramic balls, aquarium ceramic granules, aquarium ceramic filled balls, shungite, quartz, silicon pulp;
said separable, substantially cylindrical top and bottom housing portions having interior and exterior surfaces and including threaded connecting means, on open ends thereof having enlarged strengthened mating areas, away from the domed ends, enabling said separable, substantially cylindrical top and bottom housing portions to be screwed together and taken apart by turning the same with respect to each other; and
gripping portions, formed on the exterior surfaces of each of said separable, substantially cylindrical top and bottom portions; each of the gripping portions including a plurality of ribs formed on the exterior surface thereof adjacent to the enlarged, strengthened mating areas, to allow said separable top and bottom housing portions to be more easily gripped when screwing them together or taking them apart.

3. The in-line multistage shower water filter assembly of claim 2 wherein said separable, substantially cylindrical top and bottom housing portions include raised lip and skirt areas which form a raised central area for strengthening said in-line multistage shower filter assembly when it is formed by said screwed together substantially cylindrical top and bottom housing portions.

4. The in-line multistage shower water filter assembly of claim 2 wherein said separable substantially cylindrical top and bottom housing portions include enlarged strengthened mating areas comprised of a raised lip on the top housing portion adjacent a threaded male connection and a raised skirt on the bottom housing portion adjacent an internal threaded connection, so that when said separable substantially cylindrical top and bottom housing portions are screwed together they will form said in-line shower water filter with a raised central strengthened area having a top and a bottom area; and said gripping portions are formed in reduced diameter portions of said in-line multistage shower water filter assembly adjacent said top and bottom areas of said raised central strengthened area.

5. The in-line multistage shower water filter assembly of claim 4 wherein said threaded male connection and said internal threaded connection are formed so as to provide an in-line multistage shower water filter assembly with substantially equal size separable, substantially cylindrical top and bottom portions.

6. An in-line multistage shower water filter assembly comprising, in combination:
a substantially cylindrical hollow body comprised of separable substantially cylindrical top and bottom housing portions having domed ends and an internal hollow chamber formed between open ends;
an inlet connected to the domed end of said substantially cylindrical top housing portion and an outlet connected to the domed end of said substantially cylindrical bottom housing portion to allow the flow of water into and out of said internal hollow chamber;
a separate filter element mounted within said internal hollow chamber;
said separate filter element being held in said internal hollow chamber clamped between the domed ends of said separable top and bottom housing portions and having a top wall, a bottom wall and an annular side wall forming an inner hollow chamber;
a filter media substantially filling said inner hollow chamber of said separate multistage filter element, inside the body being incorporated the next filtration stages with: granulated activated coconut carbon, unique structure of polypropylene cotton, kinetic degradation fluxion 55, calcium sulfite, alkaline ceramic balls, magnetic energy ceramic balls, nano silver antibacterial ceramic balls, Kangen water ceramic filter discs, Kangen water plus ceramic balls, hydrogen water ceramic balls, oxidation/reduction potential water magnesium granules, alkaline water calcium ceramic balls, alkaline water plus antioxidant ceramic balls, oxidation/reduction potential water negative potential ceramic balls, tourmaline ceramic balls, maifan stone, potassium metasilicate ceramic balls, vitamin C ceramic balls, microporous antibacterial ceramic balls, negative ion ceramic balls, far-infrared ceramic balls, zeolite bioceramic balls, activated alumina balls, laundry ceramic granules, laundry balls, dechlorination balls, germanium balls, magnetic energy ceramic balls, aquarium ceramic granules, aquarium ceramic filled balls, shungite, quartz, silicon pulp;
said separable, substantially cylindrical top and bottom housing portions having interior and exterior surfaces and include threaded connecting means at the open ends thereof enabling said separable, substantially cylindrical top and bottom housing portions to be screwed together and taken apart by turning the same with respect to each other;
gripping portions formed on the exterior surfaces of each of said separable, substantially cylindrical top and bottom portions; each of the gripping portions including a plurality of strengthening ribs formed on the exterior surface thereof adjacent to enlarged strengthened mating areas, to allow said separable top and bottom housing portions to be more easily gripped when screwing them together or taking them apart;
and the enlarged, strengthened mating areas of said separable substantially cylindrical top and bottom housing portions including a raised lip on the top housing portion adjacent a threaded male connection and a raised skirt on the bottom housing portion adjacent an internal threaded connection, so that when said separable substantially cylindrical top and bottom housing portions are screwed together said in-line multistage shower water filter will be formed with a raised central strengthened area having a top and a bottom area.

7. An in-line multistage shower water filter assembly of claim 1 wherein said substantially cylindrical separable top and bottom housing portions are easily connected and taken apart so as to allow said separate filter element to be easily removed and reversed for reinsertion back into said internal hollow chamber whereby when said substantially cylindrical separable top and bottom housing portions are connected together again, water flowing through said in-line filter assembly will backflush said reversed separate filter element to clean the same.

8. An in-line multistage shower water filter assembly of claim 1 wherein said separate filter element is an in-line assembly that allows water to pass directly through said separate filter element.

9. An in-line multistage shower water filter assembly of claim 1 wherein said separate filter element is bi-directional and defines an in-line assembly having a single fluid flow path, which is parallel to a longitudinal axis of the multistage shower filter assembly.

10. An in-line multistage shower water filter assembly of claim 2 wherein said substantially cylindrical separable top and bottom housing portions are easily connected and taken apart so as to allow said separate filter element to be easily removed and reversed for reinsertion back into said internal hollow chamber whereby when said substantially cylindrical separable top and bottom housing portions are connected together again, water flowing through said in-line filter assembly will backflush said reversed separate multistage filter element to clean the same.

11. An in-line multistage shower water filter assembly of claim 2 wherein said separate filter element is bi-directional and defines an in-line assembly having a single fluid flow path, which is parallel to a longitudinal axis of the multistage shower filter assembly.

12. An in-line multistage shower water filter assembly of claim 3 wherein said substantially cylindrical separable top and bottom housing portions are easily connected and taken apart so as to allow said separate filter element to be easily removed and reversed for reinsertion back into said internal hollow chamber whereby when said substantially cylindrical separable top and bottom housing portions are connected together again, water flowing through said in-line filter assembly will backflush said reversed separate multistage filter element to clean the same.

13. An in-line multistage water shower water filter assembly of claim 3 wherein said separate filter element is an in-line assembly that allows water to pass axially through said separate multistage filter element.

14. An in-line multistage water shower filter assembly of claim 3 wherein said separate filter element is bi-directional and defines an in-line assembly having a single fluid flow path, which is parallel to a longitudinal axis of the multistage shower filter assembly.

15. An in-line multistage water shower filter assembly of claim 4 wherein said separate filter element is an in-line assembly that allows water to pass axially through said separate multistage filter element.

16. An in-line multistage shower water filter assembly of claim 5 wherein said substantially cylindrical separable top and bottom housing portions are easily connected and taken apart so as to allow said separate filter element to be easily removed and reversed for reinsertion back into said internal hollow chamber whereby when said substantially cylindrical separable top and bottom housing portions are connected together again, water flowing through said in-line filter assembly will backflush said reversed separate multistage filter element to clean the same.

17. An in-line multistage shower water filter assembly of claim 5 wherein said separate filter element is an in-line assembly having a single fluid flow path that is parallel to a longitudinal axis of the shower filter assembly that allows water to pass directly through said separate filter element, and wherein said separate multistage filter element is bi-directional.

18. An in-line multistage shower water filter assembly of claim 6 wherein said substantially cylindrical separable top and bottom housing portions are easily connected and taken apart so as to allow said separate filter element to be easily removed and reversed for reinsertion back into said internal hollow chamber whereby when said substantially cylindrical separable top and bottom housing portions are connected together again, water flowing through said in-line multistage filter assembly will backflush said reversed separate multistage filter element to clean the same.

19. An in-line multistage shower water filter assembly of claim 6 wherein said separate multistage filter element is an in-line assembly that allows water to pass axially through said separate multistage filter element.

20. An in-line multistage shower water filter assembly of claim 7 wherein said substantially cylindrical separable top and bottom housing portions are easily connected and taken apart so as to allow said separate multistage filter element to be easily removed and reversed for reinsertion back into said internal hollow chamber whereby when said substantially cylindrical separable top and bottom housing portions are connected together again, water flowing through said in-line multistage shower water filter assembly will backflush said reversed separate filter element to clean the same, said separate filter element is an in-line assembly having a single fluid flow path that is parallel to a longitudinal axis of the shower filter assembly that allows water to pass axially through said separate filter element, and wherein said separate multistage filter element is bi-directional.
